(19) United States
(12) Patent Application Publication
(10) Pub. No.: US 2011/0277383 A1
(43) Pub. Date: Nov. 17, 2011

(54) Methods, Devices and Kits for Mushroom Production

(75) Inventors: Nikhil ARORA, Irvine, CA (US); Alejandro VELEZ, Emeryville, CA (US)

(73) Assignee: B.T.T.R. VENTURES LLC, Oakland, CA (US)

(21) Appl. No.: 13/104,670

(22) Filed: May 10, 2011

Related U.S. Application Data
(60) Provisional application No. 61/333,979, filed on May 12, 2010.

(51) Int. Cl. A01G 1/04; A01G 31/00

(52) U.S. Cl. 47/59 S; 47/1.1; 71/5

(57) ABSTRACT

Methods, devices and kits are described for making a growing substrate from recycled coffee grounds and growing mushrooms.

### CROSS-REFERENCE

This application claims the benefit of 61/333,979 filed on May 12, 2010 entitled “Methods Devices and Kits for Mushroom Production” the contents of which are incorporated herein.

### BACKGROUND OF THE INVENTION

Oyster mushrooms have been grown commercially on various cellulose rich substrates (i.e. straw, sawdust). Traditionally used substrates sterilization prior to use. A the traditional method for growing oyster mushrooms commercially includes, for example, the steps of: Obtaining a growing medium (substrate). The substrate is often a mixture of sawdust and straw.

Sterilizing the substrate. Sterilizing the substrate is typically accomplished through the use of large steam chambers/vats 10 as shown in FIG. 1. The sterilization process can account for up to ⅓ of the operating costs. Inoculating the substrate with spawn into filter patch, high-heat resistant, and autoclave resistant plastic bags 20 (available, for example, from www.unicornbags.com) as illustrated in FIG. 2; Incubating the substrate 30 which includes having the bags sit in a dark, approximately 60-75 Fahrenheit degree room for approximately three weeks as the mycelium 2 colonizes through the substrate to achieve the result shown in FIG. 3; Fruiting—wherein the bags are shocked into growing by altering the environmental conditions within the bag. This is often achieved by opening the bags (CO2 change), dropping the environmental temperature in a ‘fruiting’ room (to approx 50-60 degrees Fahrenheit), increasing the environmental humidity to approximately 95%, and lastly, by increasing the amount of light the substrate/spawn filled bags are exposed to. These changes then ‘shock’ the oyster mushrooms into growing (first pinheads appear, and then those slowly transform into larger oyster mushrooms with the caps).

FIGS. 3 and 4 illustrate other bag 2 solutions configured for garden mushroom kits, and FIGS. 5 and 6 illustrate currently available tenting apparatuses 4 used for mushroom kits;

Sterilization chambers used produce copious amounts of residual water, often requiring a pond of its own to contain the waste water. The sterilization chambers therefore require commercial mushroom operations to exist in more rural areas, often far away from the consumers who directly consume the mushrooms (urban/suburban consumers). Sterilized substrate is required in order to decrease the rates of contamination throughout the oyster mushroom incubation and fruiting stages.

Other previously presented ideas related to growing mushrooms can be found in:

| Pat. No. | Patent Date | Inventor | Title |
|---|---|---|---|
| USP 3,996,038 | Dec. 07, 1976 | Toth et al. | Mushroom Growing |
| | | | Process |
| USP 4,127,965 | Dec. 05, 1978 | Mee | Method for Growing |
| | | | Wood Mushroom |
| USP 4,333,757 | Jun. 09, 1982 | Kurzman Jr. | Mushroom-Growing |
| | | | Medium |
| USP 4,455,161 | Jun. 19, 1984 | Cohen et al. | Trace Element |
| | | | Fertilizer Composition |
| USP 4,457,945 | Jul. 03, 1984 | Inamura et al. | Mushroom Growing |
| | | | by Utilizing Sewage |
| | | | Sludge Compost and |
| | | | Re-Utilization of the |
| | | | Used Compost as |
| | | | Livestock Feed |
| USP 4,637,163 | Jan. 20, 1987 | Pellinen et al. | Method of Growing |
| | | | Edible Mushrooms |
| USP 4,674,228 | Jun. 23, 1987 | Murata et al. | Process of Shitake |
| | | | (Lentinus Edodes) |
| | | | Cultivation |
| USP 4,852,297 | Aug. 01, 1989 | Moren | Method and Article of |
| | | | Manufacture for |
| | | | Producing Mushrooms |
| | | | from Self |
| | | | Contained Vessels |
| USP 4,874,419 | Oct. 17, 1989 | Wu | Substrate for Growing |
| | | | Shitake Mushrooms |
| USP 5,538,523 | Jun. 23, 1996 | Benetti | Mushroom Growing |
| | | | Medium |

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY OF THE INVENTION

An aspect of the disclosure is directed to a mushroom growing kit. The mushroom growing kit comprises: a container; a liner positionable within the container; a substrate of coffee grounds; and mushroom spawn. The container can be a blank that is configured to provide an aperture on at least one side wall. Additional apertures can be provided. Additionally, a humidifying apparatus can be provided. In some configurations, the liner is a plastic bag. The substrate of coffee grounds can be sterilized one or more times prior to use. In still other configurations, the container is a two-dimensional container blank configured to be erectable into a three-dimensional container. In still other configurations, the kit can further comprise one or more of calcium carbonate and sodium bicarbonate.

Another aspect of the disclosure is directed to a mushroom growing kit comprising: a container; a liner positionable within the container; a cellulose rich growing medium; sodium bicarbonate; and mushroom spawn. The container can be a blank that is configured to provide an aperture on at least one side wall. Additional apertures can be provided. Additionally, a humidifying apparatus can be provided. In some configurations, the liner is a plastic bag. The substrate can be sterilized one or more times prior to use. In still other configurations, the container is a two-dimensional container blank configured to be erectable into a three-dimensional container. In still other configurations, the kit can further comprise one or more of calcium carbonate and sodium bicarbonate. Additionally, the cellulose rich growing medium is selected from the group comprising coffee grounds and saw dust.

Still another aspect of the disclosure is directed to a method of creating a growing medium comprising the steps of: obtaining used coffee grounds; removing water from the coffee grounds; and removing acidity from the coffee grounds. Additional steps include the step of aerating the coffee grounds, mixing the substrate of coffee grounds and calcium carbonate. In some aspects of the method, the step of removing acidity from the coffee grounds further comprises the step of adding one or more of calcium carbonate and sodium bicarbonate to the coffee grounds. As will be appreciated by those skilled in the art, the addition of calcium carbonate and sodium bicarbonate need not be to the same quantity of substrate. In still other aspects, the growing medium is used for growing mushrooms further comprising the step of adding mushroom spawn to the substrate.

Yet another aspect of the disclosure is directed to a method of creating a growing medium that prevents early fruiting comprising the steps of: providing a cellulose rich substrate; removing water from the substrate; and selectively adding sodium bicarbonate to an area of the substrate where growth is to be inhibited. Additional steps include the step of aerating the substrate, mixing the substrate and calcium carbonate. As will be appreciated by those skilled in the art, the addition of calcium carbonate and sodium bicarbonate need not be to the same quantity of substrate. In still other aspects, the growing medium is used for growing mushrooms and further comprises the step of adding mushroom spawn to the substrate.

An additional aspect of the disclosure is directed to a device for growing mushrooms comprising: a container; a liner positionable within the container; a substrate of coffee grounds; and mushroom spawn. In some configurations, the container is a container blank configured to provide an aperture on at least one side wall. Additionally, a humidifying apparatus can be incorporable into the container. A plastic bag liner can also be provided. The container is a two-dimensional container blank configured to be erectable into a three-dimensional container. Still another additional aspect of the disclosure is directed to a device for growing mushrooms comprising: a container; a liner positionable within the container; a cellulose rich substrate with sodium bicarbonate in a portion thereof; and mushroom spawn. In some configurations, the container is a container blank configured to provide an aperture on at least one side wall. Additionally, a humidifying apparatus can be incorporable into the container. A plastic bag liner can also be provided. The container is a two-dimensional container blank configured to be erectable into a three-dimensional container.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a traditional process for growing mushrooms;

FIG. 2 illustrates a spawn into filter patch, high-heat resistant, and autoclave resistant plastic bag;

FIGS. 3 and 4 illustrate bags configured for garden mushroom kits;

FIGS. 5 and 6 illustrate currently available tenting apparatus' used for mushroom kits;

FIGS. 7a-c and 8 illustrate a mushroom growing apparatus configured according to the current disclosure; and

FIGS. 9-11 illustrates a mushroom growing apparatus, such as those illustrated in FIGS. 7-8 further adapted to provide a humidity chamber wherein the humidity chamber is removable and replaceable.

### DETAILED DESCRIPTION OF THE INVENTION

### I. Mushroom Production Utilizing Coffee Grounds as a Substrate

Coffee grounds, such as those obtained from coffee houses (e.g., Starbucks®, Peet's®, Tully's®, etc.), are used as a growing substrate for mushroom production. The traditional growing process, such as that described above, uses substrates such as straw or sawdust, all of which require costly and lengthy sterilization processes. Sterilizing substrate processing correlates to about of the cost of growing for traditional growers. By using coffee grounds as a substrate, the need for sterilization is eliminated and the costs of growing mushrooms significantly. The use of coffee grounds as the growing substrate for mushroom production, solves the problem of having to invest significant time and capital into sterilizing substrate.

Advantages of this solution include: reduced footprint for growing (a mushroom production facility/farm requires substantially less real estate as no sterilization vats or chambers are required. This allows for operation to be established in urban settings closer to customers and distribution centers. This decreases distribution costs as well as increases shelf life and freshness of the mushrooms due to less transportation); reduced operating costs for traditional mushroom facilities goes into the sterilization of substrates (By utilizing coffee grounds, a mushroom farm can eliminate this cost and remove a lengthy step from the growing process); reduced environmental impact (Coffee grounds are one of the largest waste streams in America, with stores generating, on average, between 50-100 lbs of waste per day. By utilizing coffee grounds for producing mushrooms, this large waste stream can be diverted and have valued added to it).

Utilizing coffee grounds for mushroom production involves the following steps:
a. In one aspect, coffee grounds (spent coffee left after brewing the coffee beans in café) are collected. Coffee grounds, after being brewed with boiling hot water, are already pasteurized and sterile enough for mushroom production.
   However, in some embodiments, quick pasteurization of the coffee grounds or suitable urban waste or growing media can also be performed after collection.
      i. Coffee grounds collected:
         1. Employees place just the grounds and coffee filters into plastic bags (no other organic or inorganic waste), and immediately tie the bags closed
         2. Bags of coffee grounds can be kept for up to 7 days before being processed through the steps below
b. Processing the coffee grounds for use as a growing substrate
   i. Step 1: Sorting
      1. The grounds are placed in a pre-cleaned suitable container of ample size for the purposes of collection. Suitable containers are, for example, plastic bins of ˜20 gallon in volume. Other sizes can be used without departing from the scope of the disclosure. The grounds are analyzed to confirm that no other matter is in the bag except for the grounds and coffee filters.
   ii. Step 2: Drying—Removing high water content in the grounds
      Note: The drying process below utilizes a large, 2 horse power coffee press (50 gallon) specifically designed and engineered for our business process. However, any sort of wine press or other device can be used depending on the quantity of coffee grounds a grower wishes to process at a time. Prior to use, the press is cleaned with biodegradable, FDA approved soap. Between each load, the press must be cleansed thoroughly.
      1. As the grounds are sorted for cleanliness, they are placed into the barrel of the press. The press is loaded to capacity.
      2. The grounds (and coffee filters) are pressed one or more times to remove excess moisture and fluid. Pressing can be achieved with a suitable amount of force. In some configurations of the process, approximately 1-3 tons of force are used, more preferably 2 tons of force is used.
      3. The dried coffee grounds/filters are placed into sterile bins
   iii. Aeration
      1. To allow for proper gas exchange and air exchange throughout the growing medium, the coffee filters originally used during the brewing process can be left in the coffee mixture described above. A minimum of 1-10%, more preferably 5%, of the substrate is typically filters or some other suitable material that facilitates gas and air exchange. The gas and air exchange facilitation medium helps break-up the dense grounds and therefore allow for the air exchange. The mushroom mycelium can break down the cellulose in, for example, the filters and convert it into carbohydrates and proteins.
      iv. Removing Acidity
         Note: Prior to inoculating the substrate (dried coffee grounds and filters), the substrate must be brought to a proper pH for mushroom production
         1. Measure the weight of the dried substrate
         2. Mix in calcium carbonate at a ratio of from about 1% to 15%, more preferably 3-8%, of the weight of the substrate.
      v. Inoculating
         1. Inoculate the substrate by mixing in mushroom spawn (grain/rye based) at a ratio of from about 1% to about 35%, more preferably about from 5% to about 20% of the weight of the substrate. This weight is typically, but not necessarily, determined prior to addition of calcium.
      vi. Mixing
         1. Mix the substrate (grounds and filters) thoroughly with the calcium carbonate and spawn.
         2. Substrate is now ready to be placed into bags or bottles and incubated as done through traditional growing processes. No sterilization has been required or performed.

To prevent the mushrooms from fruiting early and enable adequate shelf life in a retail environment, baking soda (sodium bicarbonate) can be added to the top. The use of baking soda can be used with any of the growing media to facilitate shelf life.

As will be appreciated by those skilled in the art after review of this disclosure, coffee grounds, having gone through the brewing process, have already been pasteurized to a level of sterility acceptable for mushroom production. The coffee grounds, prior to being inoculated, must be processed to resolve 3 issues: 1) High humidity/water content, 2) density, 3) acidity. Too much water and density in the substrate does not allow for proper air exchange during the incubation period in mushroom production, and a high level of acidity increases the chance for contamination in the growing substrate.

Moreover, additional steps can be added without departing from the scope of the disclosure. Moreover, one or more steps disclosed above can be eliminated or replaced without departing from the scope of the disclosure.

As will be appreciated by those skilled in the art, while the disclosure discusses the use of coffee grounds as a growing media, any cellulose rich substrates can be employed instead. Suitable cellulose rich media include, for example, straw and sawdust.

### II. Mushroom Kits

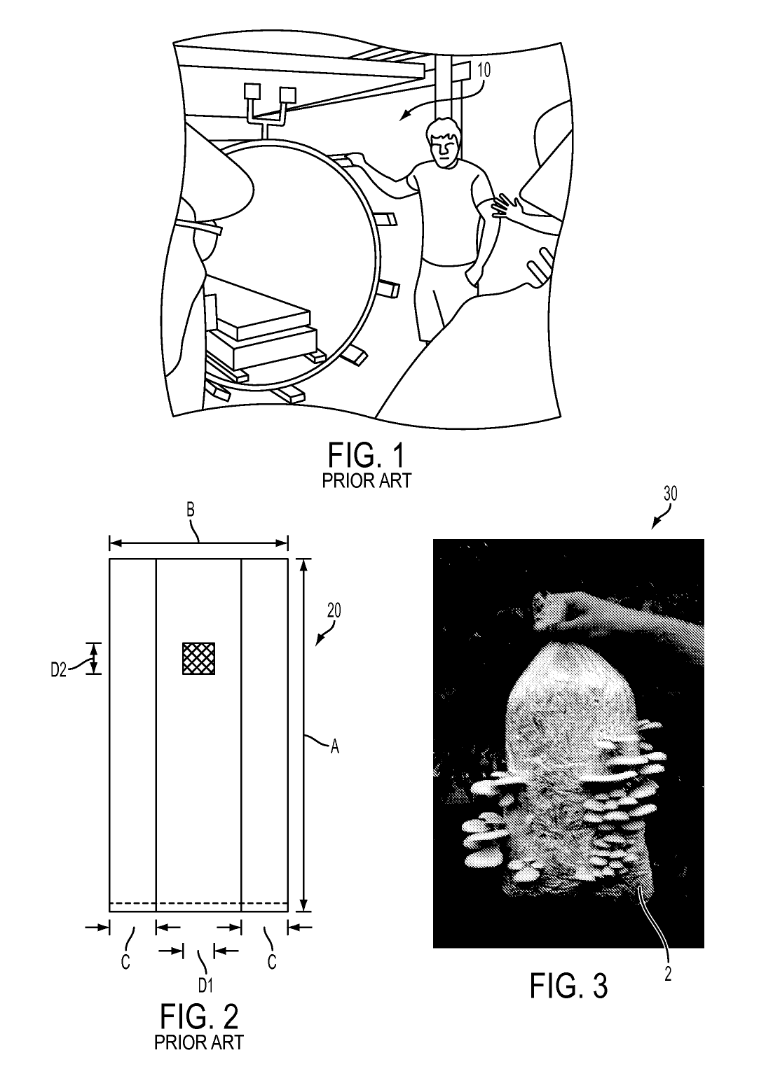

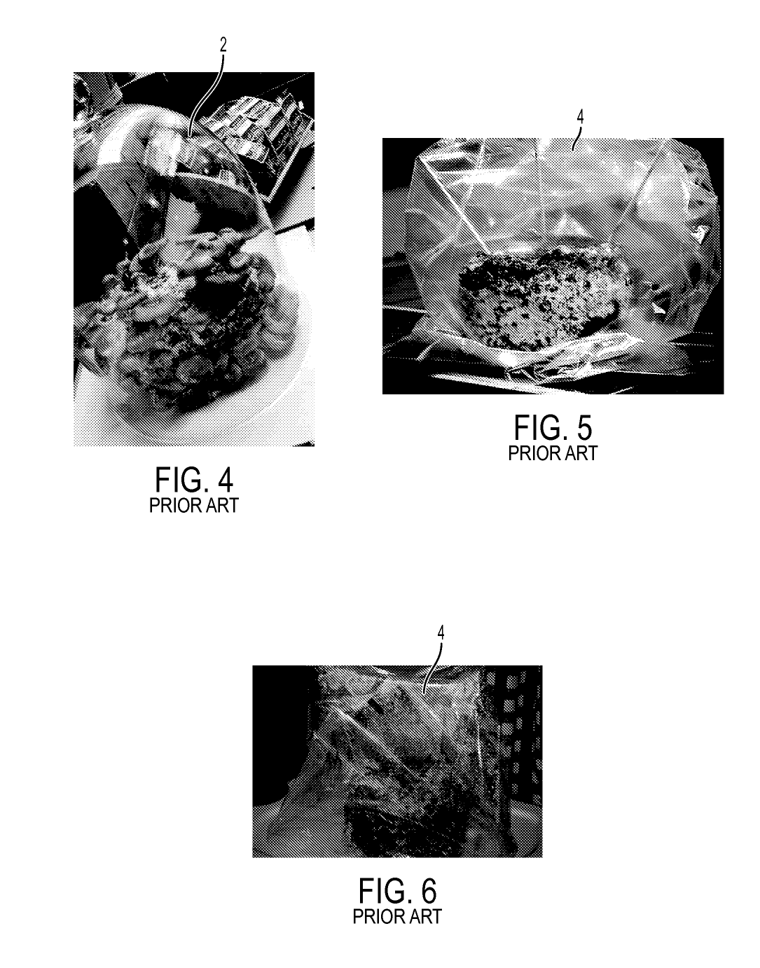

Mushroom kits used for amateur, small-scale mushroom cultivation have been in existence for many years. However, as discussed above, current design of mushroom kits, as shown in FIGS. 3 and 4, are characterized by bags approximately 12″ in width, 6″ in height, an d 6″ in length. The kits come in plastic bags in which sits the colonized substrate from which the mushrooms will fruit out of Many kits offer humidity tents that cover the entire kit and take up over 2 cubic feet in space. mushrooms will grow from these kits wherever the consumer creates a hole in the bag.

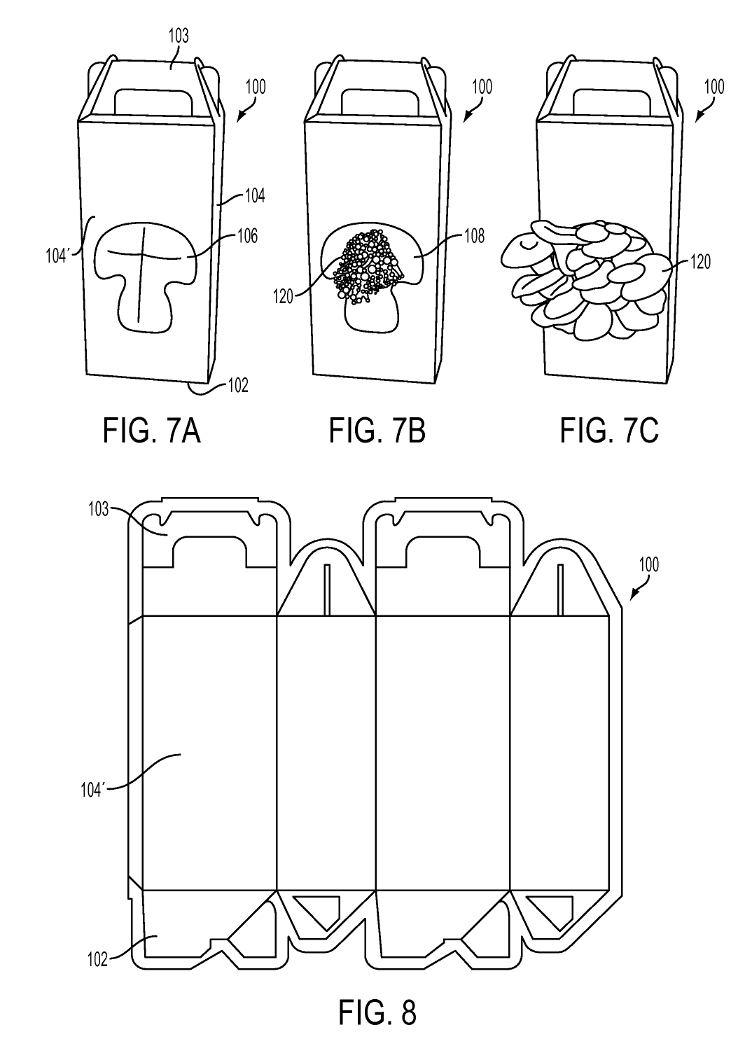

As shown in FIGS. 7-11, the mushroom kit of this disclosure utilizes a container. The container includes a box comprising a bottom wall and four side walls as shown in FIGS. 7-8. Each of the side walls 104, 104′ are pivotably connected to the bottom wall 102. A bore or other mating feature is provided that enables the end walls to mate when the box is folded into shape. Each of the side walls is pivotably connected to the a portion of the bottom wall 102. FIG. 8 illustrates the container in a flattened condition prior to being formed into a three dimensional structure. FIG. 7 illustrates the contained with the side wall aperture in its three dimensional shape with the top of the contained folded into a handle structure. As will be appreciated by those skilled in the art, a variety of containers and container blanks can be employed without departing from the scope of the disclosure. See, for example, U.S. Pat. No. 2,549,682 to Grossniklaus for “Foldable Box;” 5,201,462 to Sada et al. for “Liquid Container;” and U.S. Patent Publication US 2010/0001055 A1 to Watterson for “Recycling Kit and Method.”

Several advantages of this configuration and design include: elimination of bulky packaging; focused and easily identifiable growing area from where the customers know where to expect growth; small cubic design easily placed within the living space; instructions incorporatable onto the housing for the kit; no bulky tenting as with previous solutions shown in (FIGS. 5 and 6); previously available kits include no clear instructions or focus area for secondly/additional crops; and previously available kits have no designated area to hold any sort of misting or humidifying instruments.

The mushroom kits disclosed herein provide a space efficient and clear to understand and ‘operate’ kit. The kit packages a mister, humidity chamber, and instructions in a compact design that not only connotes a theme of growing mushrooms through the special front mushroom cut-out, but also clearly indicates where the mushrooms will form for a second time through the back perforation.

The mushroom kit can be configured to fit within a square, cylindrical, rectangular, or other carton shaped container with a flat bottom and vertical sides that can easily and conveniently fit on any window sill or counter. The top handle 103 is designed to not only offer a convenient way of carrying the kit, but it also holds a 0.67 oz mister and an anchor from which to hang the housing. Prior to assembly, the container is formed from a flat piece of material, such as cardboard, as shown in FIG. 8.

The mushroom kit itself is comprised of a: a clear, sealed plastic bag 108 (in which the colonized cellulose rich substrate, including, but not limited to a substrate developed using coffee grounds as described above is held) that fits inside a container 100. The container has a bottom 102 and four walls 104, 104 formable to contain the bag of coffee grounds. The box 100 has a cut-out 106 or removeable section along one of the four walls 104′ through which the mushrooms 120 will emerge after a slit has been placed in the exposed plastic bag. Additional cut-outs can be provided along any or each of the container walls to provide up to four areas of exposed plastic from which mushrooms will emerge upon incision of the plastic.

Optionally, a mini-greenhouse apparatus 110 can also be provided. The greenhouse apparatus can, for example, be a clear plastic saucer, approximately 4″ in diameter, that comes packaged with the kit and can, for example, be tied to the handle. Although, as will be appreciated by those skilled in the art, other materials can be used without departing from the scope of the disclosure. The greenhouse apparatus is any suitable humidity generating device and is typically configured to quickly slide into place at the cut-out 106 to keep the area directly above the growing area at high humidity. A mister, e.g. a spray bottle, such as a 0.67 oz spray bottle, can also be packaged under the handle and serves as a humidifying instrument for consumers. Alternatively to the user of the mini-greenhouse apparatus, the end user can soak the bag for a 23 hour period prior to misting. In another embodiment, an aperture can be provided through which water is added in an amount sufficient provide adequate dampness.

### III. Mini-Greenhouse Humidity Chamber for Mushroom Kit

An important factor in mushroom production is creating a humid environment. High humidity, around 80-95%, is required to fruit succulent, and ‘meaty’ mushrooms. The high humidity also serves as an environmental shock that triggers the mushrooms into growing. Often, a dry environment and lack of humidity prevents mushrooms from growing from mushroom kits. Many mushroom kits provide large humidity tents (FIGS. 5 and 6) that drape the entire kit, and are awkwardly held up with poles and plastic bags. The humidity tents require a lot of space (often around 2 cubic feet) and do not direct humidity precisely to the growing area. Problems with mushroom kits and humidity are therefore as follows: many kits offer no way of controlling and keeping humidity high enough to “shock” mushrooms into growing and primordia from forming, thereby creating a large percentage of ‘failed’ kits; kits that do offer humidity tents/chambers are often large, obtrusively designed constructs that are both space inefficient, not elegant for consumer household spaces, and do not work well as they do not direct and focus the increased humidity to the actual growing area/exposed growing substrate. The greenhouse feature 110 provided in some embodiments is large enough to humidify the growing area and small enough to be packaged in a kit. Moreover, the greenhouse feature 110 provides a humidity chamber that can be utilized/implemented by consumers simply and easily; created a humidity chamber/environment that is more effective by focusing the higher humidity towards the actual growing area on the substrate; enables use of the colonized substrate developed using coffee grounds as described above

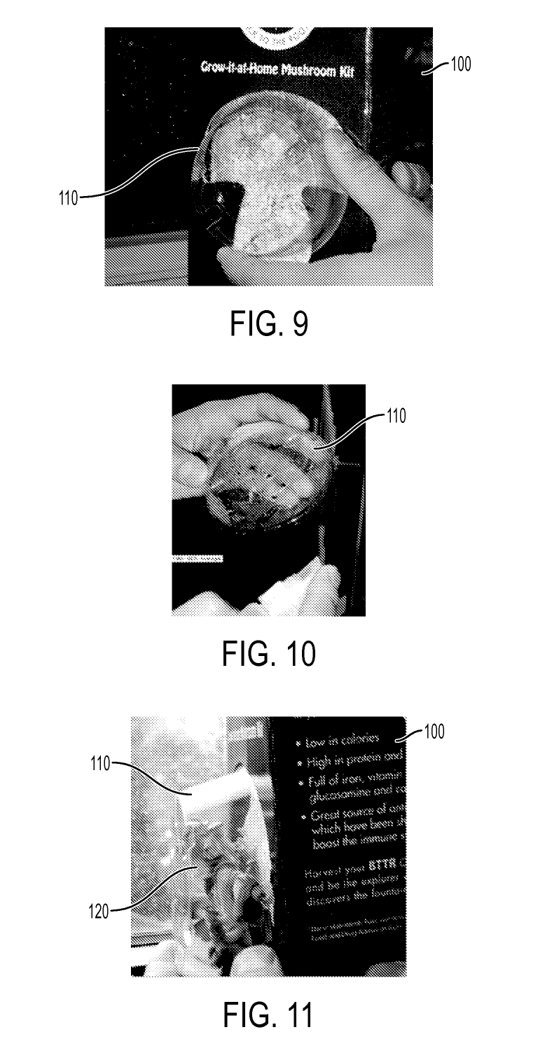

The greenhouse also provides precise and targeted humidity control, the mushroom greenhouse is only a small addition to the kit and does not require large amounts of additional space as other humidity tents. The mushroom greenhouse comprises a plastic vinyl polymer saucer (of polyethylene material) with a diameter of approximately 4″ with a slight lip that allows the saucer to slide above the cut-out (between the cardboard packaging and plastic bag). (FIG. 9)

The mushroom greenhouse has a ¼″ hole punctured at the top to allow it to be strung to a cord and tied to the kit for packaging purposes. The small hole also allows for air exchange within the mushroom greenhouse. Consumer use the mushroom greenhouse by misting directly into the mushroom greenhouse (FIG. 10) and then fastening it back onto the kit. This is done twice a day, and allows for a very humid environment without directly wetting the substrate.

In configurations which include a greenhouse feature, once primordia (“pinheads”) begin to form, the mushroom greenhouse is removed and misting directly to the mushrooms with the mister begins. (FIG. 11). Advantages of the design of the greenhouse include, for example,
1) better growth due to concentrated high humidity over the growing region. Helps create a quicker and larger (by weight) crop of mushrooms.
2) non-obtrusive packaging does not scare customers away from purchasing the kit (as opposed to a large, bulk tent)
3) Simple to use—just slide over the mushroom cut-out.
4) The added accessory provides more confidence to consumers that they are indeed buying a “kit” and getting their money's worth

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A mushroom growing kit comprising:
a) a container;
b) a liner positionable within the container;
c) a substrate of coffee grounds; and
d) mushroom spawn.

2. The mushroom kit of claim 1 wherein the container blank is configured to provide an aperture on at least one side wall.

3. The mushroom kit of claim 1 further comprising a humidifying apparatus.

4. The mushroom kit of claim 1 wherein the line is a plastic bag.

5. The mushroom kit of claim 1 wherein the substrate of coffee grounds is sterilized.

6. The mushroom kit of claim 1 wherein the container is a two-dimensional container blank configured to be erectable into a three-dimensional container.

7. The mushroom kit of claim 1 further comprising calcium carbonate.

8. The mushroom kit of claim 1 further comprising sodium bicarbonate.

9. A mushroom growing kit comprising:
a) a container;
b) a liner positionable within the container;
c) a cellulose rich growing medium;
d) sodium bicarbonate; and
e) mushroom spawn.

10. The mushroom kit of claim 9 wherein the container blank is configured to provide an aperture on at least one side wall.

11. The mushroom kit of claim 9 further comprising a humidifying apparatus.

12. The mushroom kit of claim 9 wherein the line is a plastic bag.

13. The mushroom kit of claim 9 wherein the cellulose rich growing medium is selected from the group comprising coffee grounds and saw dust.

14. The mushroom kit of claim 10 wherein the cellulose rich growing medium is sterilized.

15. The mushroom kit of claim 9 wherein the container is a two-dimensional container blank configured to be erectable into a three-dimensional container.

16. The mushroom kit of claim 9 further comprising calcium carbonate.

17. A method of creating a growing medium comprising the steps of:
a) obtaining used coffee grounds;
b) removing water from the coffee grounds; and
c) removing acidity from the coffee grounds.

18. The method according to claim 17 further comprising the step of aerating the coffee grounds.

19. The method according to claim 17 wherein the step of removing acidity from the coffee grounds further comprises the step of adding calcium carbonate to the coffee grounds.

20. The method according to claim 17 further comprising the step of mixing the substrate of coffee grounds and calcium carbonate.

21. The method according to claim 17 wherein the growing medium is used for growing mushrooms further comprising the step of adding mushroom spawn to the substrate.

22. The method according to claim 17 further comprising the step of adding sodium bicarbonate.

23. A device for growing mushrooms comprising:
a) a container;
b) a liner positionable within the container;
c) a substrate of coffee grounds; and
d) mushroom spawn.

24. The device of claim 23 wherein the container blank is configured to provide an aperture on at least one side wall.

25. The device of claim 23 further comprising a humidifying apparatus.

26. The device of claim 23 wherein the line is a plastic bag.

27. The device of claim 23 wherein the substrate of coffee grounds is sterilized.

28. The device of claim 23 wherein the container is a two-dimensional container blank configured to be erectable into a three-dimensional container.
